(19) United States
(12) Patent Application Publication
(10) Pub. No.: US 2012/0035752 A1
(43) Pub. Date: Feb. 9, 2012

(54) DATA RECORDING DEVICE AND AUDIO SYSTEM

(76) Inventor: Tetsuhiro Kohada, Tokyo (JP)

(21) Appl. No.: 13/265,548

(22) PCT Filed: Jul. 2, 2009
(86) PCT No.: PCT/JP2009/003062

§ 371 Date: Oct. 21, 2011

(51) Int. Cl. G06F 17/30

(52) U.S. Cl. 700/94; 707/823; 707/E17.01

(57) ABSTRACT

Technical Problem: It is an object of the present invention to provide a data recording device which records a data file in a recording unit at a high speed, and can also restore management data and a data file.

Solving means: A writing control unit is provided for writing write data which the writing control unit is requested to write by a file system at a position where the writing control unit is requested to write the write data by the file system when the write data has a data volume equal to or larger than a predetermined value while writing the write data in a region in a recording unit different from that managed by the file system.

### FIELD OF THE INVENTION

The present invention relates to a data recording device for recording a data file, and an audio system equipped with this data recording device.

### BACKGROUND OF THE INVENTION

As data recording devices for recording a data file, there is a data recording device which records information inputted thereto in a recording unit, such as an HDD (Hard Disk Drive), by using a file system which is one of the functions of an OS (Operating System) installed therein. Such a file system for use in a data recording device records a data file to be recorded after adding management data to the data file so as to be able to manage the recorded data even after recording the data in a recording unit.

However, when a fault, such as a power outage or a system breakdown, occurs and the recording is interrupted while the file system records management data in the recording unit, inconsistency occurs in the management data stored in the recording unit, and it becomes impossible for the file system to access the data file.

As a solution to this problem, there can be considered a method of making it possible to restore the data file in the recording unit to a state before the occurrence of a fault by recording all changes of the data file which are recorded in the recording unit by the file system in a log. However, this method of recording all the changes decreases the writing performance remarkably as compared with a case in which any change is not recorded. Therefore, the method cannot be applied to cases in which it takes much time to record a data file, such as a case of recording a large number of data files and a case of recording streaming data. Therefore, there has been provided a system which can restore management data stored in a recording unit by recording only a change in the management data and which is referred to as a journaling file system (patent reference 1).

### RELATED ART DOCUMENT

### Patent Reference

Patent reference 1: Japanese Unexamined Patent Application Publication No. 2004-185349

### SUMMARY OF THE INVENTION

### Problems to be Solved by the Invention

A problem with the journaling file system disclosed by patent reference 1 is, however, that because the journaling file system records only a change of management data, and therefore does not record any data file even if the data file is a file of data having a small size, such as database update data or system log record data, the journaling file system cannot restore these types of data files.

Therefore, it is an object of the present invention to provide a data recording device which records a data file in a recording unit at a high speed, and can also restore management data and a data file having a small volume.

### Means for Solving the Problem

In accordance with the present invention, there is provided a data recording device including: a recording unit for recording a data file therein; a file system for managing the data file recorded in the recording unit; and a writing control unit for writing the data file and management data about this data file in the recording unit in response to a request from the file system, wherein the writing control unit writes the write data at a position where the writing control unit is requested to write the write data by the file system when the write data which the writing control unit is requested to write by the file system has a data volume equal to or larger than a predetermined value while writing the write data in a region in the recording unit different from that managed by the file system and then writes the write data written in this different region at the position where the writing control unit is requested to write the write data by the file system when the write data has a data volume smaller than the predetermined value.

### ADVANTAGE OF THE INVENTION

Because the data recording device in accordance with the present invention includes the writing control unit for writing the write data at a position where the writing control unit is requested to write the write data by the file system when the write data which the writing control unit is requested to write by the file system has a data volume equal to or larger than the predetermined value while writing the write data in a region in the recording unit different from that managed by the file system when the write data has a data volume smaller than the predetermined value, the data recording device can record data in the recording unit at a high speed, and can also restore management data and a data file having a small volume.

### BRIEF DESCRIPTION OF THE FIGURES

FIG. 1 is a block diagram showing an audio system in accordance with Embodiment 1;

FIG. 2 is a functional block diagram of a CD drive and a data recording device in accordance with Embodiment 1;

FIG. 3 is a flow chart showing an operation of a journaling driver in accordance with Embodiment 1;

FIG. 4 is a schematic diagram showing a recording operation of a conventional data recording device;

FIG. 5 is a schematic diagram showing a recording operation of a conventional data recording device different from that shown in FIG. 4;

FIG. 6 is a schematic diagram showing a recording operation of the data recording device in accordance with Embodiment 1;

FIG. 7 is a flow chart showing a restoring operation of the data recording device in accordance with Embodiment 1; and

FIG. 8 is a functional block diagram of a CD drive and a data recording device in accordance with Embodiment 2.

### EMBODIMENTS OF THE INVENTION

### Embodiment 1

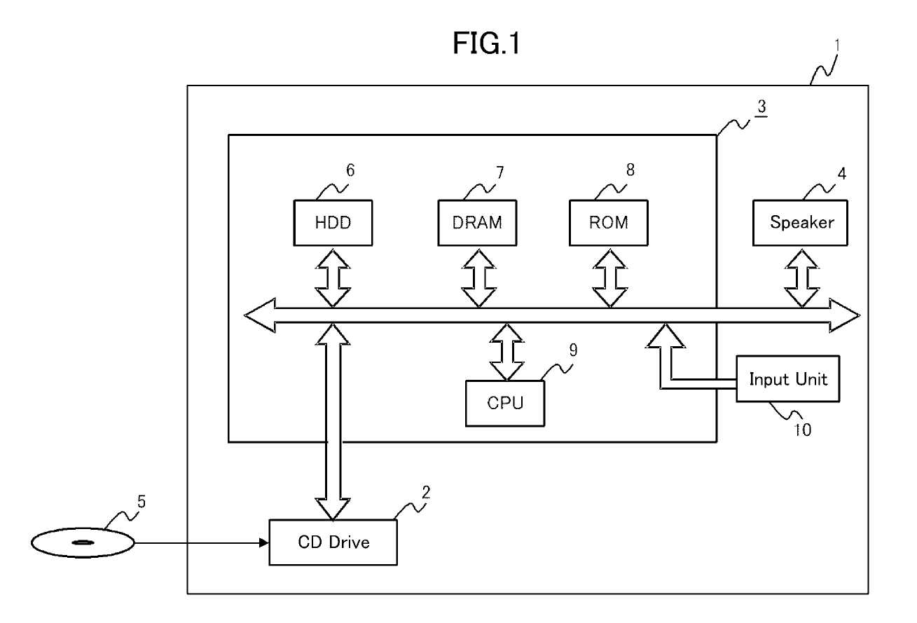

FIG. 1 is a block diagram showing an audio system 1 in accordance with Embodiment 1. For example, the audio system 1 is a vehicle-mounted audio system which a user uses to listen to music in a vehicle or the like. The audio system 1 is comprised of a CD drive 2 for reading audio data recorded in a CD (Compact Disc) 5, a data recording device 3 for recording audio data outputted from the CD drive 2 therein, an input unit 10 for commanding the data recording device 3 to record or play back audio data, and a speaker 4 for outputting a sound according to audio data outputted from the data recording device.

The CD drive 2 is a reading unit for reading audio data recorded in the CD (Compact Disc) 5. The CD drive 2 is connected to the data recording device 3, and outputs the audio data which the CD drive reads from the CD 5 to the data recording device 3.

The data recording device 3 records the audio data outputted from the CD drive 2 therein, and outputs audio data recorded therein to the speaker 4. The data recording device 3 has an HDD 6, a DRAM (Dynamic Random Access Memory) 7, a ROM (Read Only Memory) 8, and a CPU (Central Processing Unit) 8. The HDD 6 and the DRAM 7 are recording units each for recording audio data inputted thereto from the CD drive 2 therein. The DRAM 7 temporarily records audio data therein, and can carry out writing and reading at a higher speed than the HDD 6 does. Applications which operate in the CPU 9 and so on are recorded in the ROM 8. The CPU 9 controls the HDD 6 and the DRAM 7 to write audio data inputted thereto from the CD drive 2 into the HDD 6 and the DRAM 7 or read audio data from the HDD 6 and the DRAM 7 according to a command from an application recorded in the ROM 8. Audio data read from the HDD 6 and the DRAM 7 is outputted to the speaker 4. The speaker 4 is a sound output unit for outputting a sound according to the audio data outputted from the data recording device. The input unit 10 is a remote controller or the like which is operated by a user, for example, and outputs a signal for commanding the data recording device 3 to record or play back audio data.

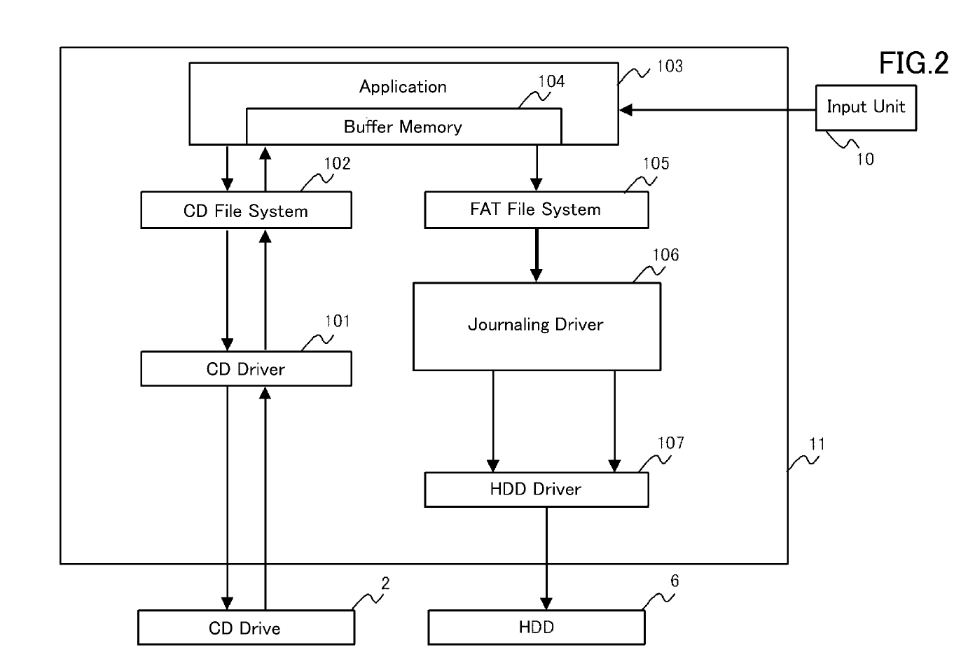

FIG. 2 is a functional block diagram of the data recording device 3 in accordance with Embodiment 1. In FIG. 2, the same components as those shown in FIG. 1 or like components are designated by the same reference numerals, and the explanation of the components will be omitted hereafter.

In FIG. 2, a control unit 11 controls the CD drive 2 and the HDD 6 to record audio data outputted from the CD drive 2 in the HDD 6. The control unit 11 is comprised of a CD driver 101 for controlling the reading of audio data from the CD 5 by the CD drive 2, a CD file system 102 for controlling the CD driver 101, an application 103 for making a request of the CD file system 102 to output audio data, a buffer memory 104 in which audio data are recorded, an FAT (File Allocation Table) file system 105 for managing audio data recorded in the HDD 6, a journaling driver 106 for controlling a position where audio data are written in the HDD 6, and an HDD driver 107 for recording audio data in the HDD. The buffer memory 104 has a region in the DRAM 7 of FIG. 1 where the buffer memory records data. The other components other than the buffer memory 104 are a program recorded in the ROM 8 and operates on an OS similarly recorded in the ROM 8. The journaling driver 106 and the HDD driver 107 construct a writing control unit.

The application 103 sends a read request to the CD file system 102 to make a request to output audio data. The CD file system 102 receives the read request from the application 103, and sends the read request to the CD driver 101 to make a request to read the audio data from the CD 5. The CD driver 101 receives the read request from the CD file system 102, and sends the read request to the CD drive 2 to make a request to read the audio data from the CD 5. The CD drive 2 receives the read request from the CD driver 101, and outputs the audio data read from the CD 5 to the CD driver 101. The CD driver 101 outputs the audio data which the CD drive 2 has outputted to the CD file system 102. The CD file system 102 outputs the audio data which the CD driver 101 has outputted to the application 103. The application 103 records the audio data which the CD file system 102 has outputted in the buffer memory 104. The audio data is recorded in the buffer memory 104 as actual data (a data file).

The application 103 sends a first write request to the FAT file system 105 to make a request to write the actual data recorded in the buffer memory 104 into the HDD 6. Information about requested write amount showing the file size (e.g., 512 KB) of the actual data which the application has made a request to write (referred to as requested write amount information from here on) is included in the first write request. The FAT file system 105 manages the actual data written into the HDD 6, and, in response to the first write request outputted from the application 103, creates metadata (having a size of 1 KB, for example) which is management data used for managing the actual data which the FAT file system has been requested to write in the HDD 6 and sends a second write request to the journaling driver 106 to make a request to write the metadata in the HDD 6. The FAT file system 105 divides the first write request into four third write requests (each having a size of 128 KB, for example) and outputs the third write requests to the journaling driver 106. The second and third write requests are outputted sequentially one by one. Information about a write start sector and the number of write sectors in a file system region on the HDD 6 which is managed by the FAT file system 105 is included in each of the second and third write requests.

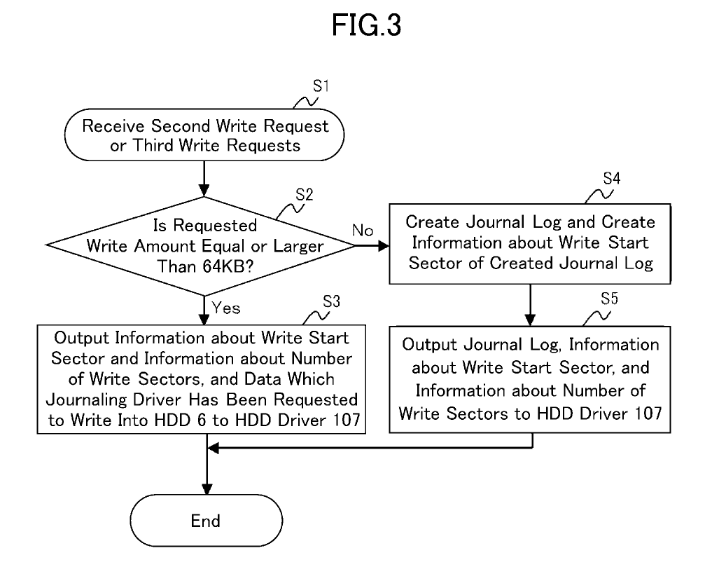

FIG. 3 is a flow chart showing an operation of the journaling driver 106. When receiving the second write request or the third write requests from the FAT system 105 (S1), the journaling driver 106 determines whether a requested write amount showing the size of the data which the FAT system has requested the journaling driver to write with the second write request or the third write requests is equal to or larger than 64 KB or smaller than 64 KB (S2). The requested write amount is calculated from the product of the number of write sectors included in the second write request or the third write requests, and the sector size depending on the HDD 6. When the requested write amount is equal to or larger than 64 KB, the journaling driver 106 outputs the information about the write start sector and the information about the number of write sectors, which are included in the second write request or the third write requests, and the data which the journaling driver has been requested to write into the HDD 6 to the HDD driver 107 (S3). In contrast, when the requested write amount is smaller than 64 KB, the journaling driver 106 creates a journal log from the data which the journaling driver has been requested to write into the HDD 6, and creates information about the write start sector of the created journal log (S4). The write start sector shown by this information about the write start sector exists in a journal log region different from the file system region managed by the FAT file system 105. The journaling driver 106 outputs the created journal log, the information about the write start sector, and the information about the number of write sectors included in the second write request or the third write requests to the HDD driver 107 (S5).

When the information about the write start sector and the information about the number of write sectors, which are included in the second write request or the third write requests, and the data which the journaling driver has been requested to write into the HDD 6 are outputted from the journaling driver 106, the HDD driver 107 writes the data which the journaling driver has been requested to write into the HDD 6 in the region on the HDD 6 which is shown by the information about the write start sector and the information about the number of write sectors which are included in the second write request or the third write requests. When the created journal log, the information about the write start sector, and the information about the number of write sectors which is included in the second write request or the third write requests are outputted from the journaling driver 106, the HDD driver 107 writes the journal log in the region on the HDD 6 which is shown by the information about the write start sector of the journal log and the information about the number of write sectors which is included in the second write request or the third write requests. After that, the HDD driver writes the data which serves as a basis for the journal log into the file system region on the basis of the journal log which has been recorded in the journal log region to complete the writing of the data into the HDD 6. In the above-mentioned way, the control unit 11 records the actual data outputted from the CD drive 2 in the HDD 6.

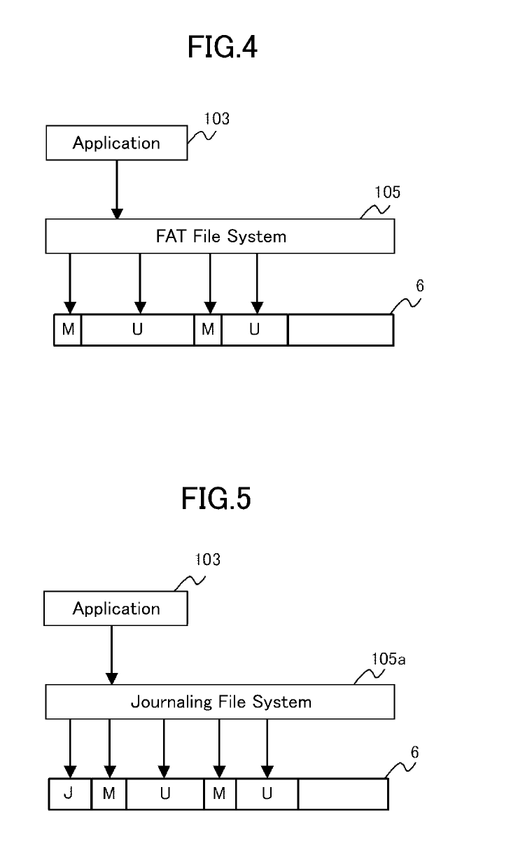

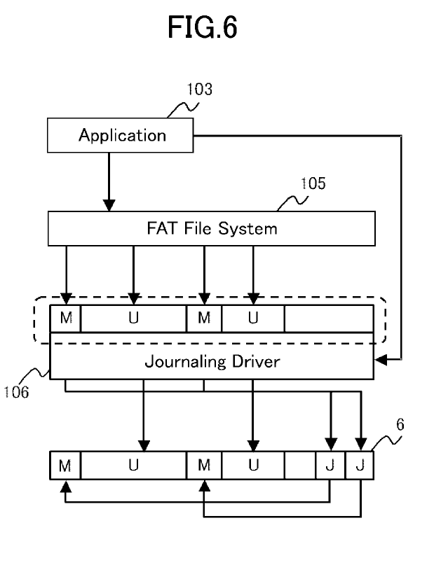

Next, a recording operation of the data recording device 3 will be explained in comparison with a conventional data recording device. FIG. 4 is a schematic diagram showing a recording operation of the conventional data recording device. FIG. 5 is a schematic diagram showing a recording operation of a conventional data recording device different from that shown in FIG. 4. FIG. 6 is a schematic diagram showing the recording operation of the data recording device 3 in accordance with Embodiment 1. In FIGS. 4 to 6, the same components as those shown in FIG. 2 or like components are designated by the same reference numerals, and the explanation of the components will be omitted hereafter. In FIGS. 4 to 6, ‘U’ shows actual data, ‘M’ shows metadata, and ‘J’ shows a journal log.

In FIG. 4, the FAT file system 105 which has received a write request from the application 103 determines the arrangement of the metadata and the actual data on the HDD 6, and writes the metadata and the actual data into the HDD 6. In the conventional data recording device as shown in FIG. 4, unless all of the metadata are written into the HDD 6, no consistency is provided in the file configuration information and the file cannot be accessed. Therefore, when a fault occurs while the conventional data recording device writes information into the HDD 6, the conventional data recording device becomes unable to access the file.

In FIG. 5, the journaling file system 105a which has received a write request from the application 103 determines the arrangement of the metadata and the actual data on the HDD 6, and, after writing what kind of change the journaling file system will make from now on into the journal log, writes the metadata and the actual data into the HDD 6. The conventional data recording device shown in FIG. 5 records a change of the metadata in the journal log which is prepared beforehand. As a result, even if a fault occurs when writing the metadata, the conventional data recording device can restore the file configuration information on the basis of the journal log. However, because the journaling file system 105a includes only a change of the metadata into the recording object, actual data which it is desirable to protect, such as database update information or system log recording information, is not recorded in the HDD.

A dashed line shown in an upper portion of the journaling driver shown in FIG. 6 virtually indicates the write position on the HDD 6 which is specified by the second and third write requests which are outputted from the FAT file system 105. Furthermore, in FIG. 6, a case in which information which is determined to have a size of 64 KB or more is actual data and information which is determined to have a size of less than 64 KB is metadata in the journaling driver 106 is shown as an example. The FAT file system 105 which has received a write request from the application 103 determines the arrangement of the metadata and the actual data on the HDD 6, and sends a write request to the journaling driver 106. When the requested write amount is small, the journaling driver 106 assumes the data to be metadata and records this metadata in the journal log on the HDD 6. In contrast, when the requested write amount is large, the journaling driver assumes the data to be actual data, and writes this actual data in the region specified by the FAT file system 105. When the writing of the actual data into the HDD 6 is completed, the application 103 sends a commit request to the journaling driver 106. In response to the commit request from the application 103, the journaling driver 106 writes the metadata into the region which the FAT file system 105 has designated as the region into which the metadata is to be written for the journaling driver 106 with the write request on the basis of the journal log on the HDD 6. Finally, the journaling driver deletes the journal log recorded in the journal region.

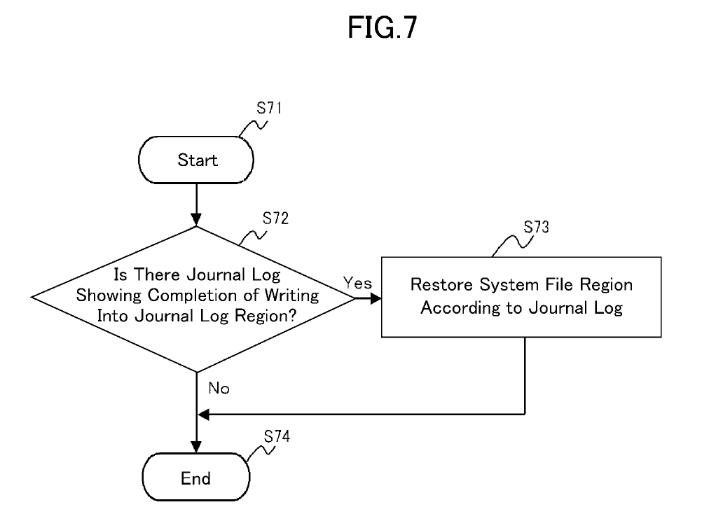

Next, a restoring method which is used at the time when inconsistency occurs in the data recorded in the recording area on the HDD 6 according to a fault, such as a power outage or a system breakdown, will be explained. FIG. 7 is a flow chart showing a restoring process.

When a fault, such as a power outage or a system breakdown, occurs, the audio system 1 enters an idle state. When the audio system 1 is restarted (S71), the control unit 11 checks to see whether or not there is a journal log showing the completion of writing into the journal log region of the HDD 6. When there is a journal log showing the completion of writing into the journal log region, the control unit restores the system file region of the HDD 6 according to the journal log. When there is no journal log showing the completion of writing into the journal log region, the control unit ends the process (S74) because there is no data to be restored.

As a situation in which inconsistency occurs in the data recorded in the recording area on the HDD 6, there are a case in which a fault occurs when a journal log is written into the journal region of the HDD 6, and a case in which a fault occurs when data which serves as a basis for a journal log recorded in the journal region is written into the file system region according to the journal log.

In the case in which a fault occurs when a journal log is written into the journal region of the HDD 6, no problem occurs because the contents of the file system region are not changed. Because the writing of the journal log has not been completed, the control unit 11 does not do anything and ends the restoring work. In contrast, in the case in which a fault occurs when data which serves as a basis for a journal log recorded in the journal region is written into the file system region according to the journal log, inconsistency occurs in the data recorded in the file system region. Because there is a journal log showing the completion of writing in the journal log region, inconsistency occurring in the data recorded in the file system region can be eliminated by performing a restoring process according to the journal log. As mentioned above, even when inconsistency occurs in the recording area due to the occurrence of a fault, the data recorded in the file system region can be restored to a state in which there is no inconsistency.

Because in the audio system 1 in accordance with Embodiment 1 the journaling driver 106 assumes information whose requested write amount shown by the requested write amount information is equal to or larger than the predetermined value as management information, and then records this information in the journal region on the HDD 6, the audio system can restore the data recorded in the file system region on the HDD 6 to a state in which there is no inconsistency even when inconsistency occurs in the data recorded in the file system region according to the occurrence of a fault, such as a power outage or a system breakdown.

Furthermore, although each of database update data and system log record data is actual data whose size is about 2 KB, the data recording device in accordance with Embodiment 1 records such data having a file size of less than the predetermined value as a journal log. Therefore, the audio system can also restore these types of actual data.

Furthermore, because the data recording device in accordance with Embodiment 1 includes the control unit for writing write data at a position where the writing control unit is requested to write the write data by the file system when the write data which the control unit is requested to write by the file system has a data volume equal to or larger than the predetermined value while writing the write data in a region in the recording unit different from that managed by the file system when the write data has a data volume smaller than the predetermined value, the data recording device records the data in the recording unit at a high speed, and can also restore management data and data files.

Furthermore, in a general vehicle-mounted audio system, an FAT file system which does not have a fault restoration function, such as a journaling file system, is used as a file system. In the case of applying the journal file system described in Embodiment 1 to a current vehicle-mounted audio system, it is difficult to retain compatibility with an existing FAT file system and so on, and a large number of man-hours for development are needed. In contrast with this, the vehicle-mounted audio system in accordance with Embodiment 1 can implement a fault restoration function by using an existing FAT file system.

Although in Embodiment 1 the case in which the data recording device is applied to the vehicle-mounted audio system is explained, the system to which the data recording device can be applied is not limited to the audio system. For example, video information recorded in an optical recording medium 20 can be recorded in the HDD 6 in the data recording device. As an alternative, the data recording device can be applied to a navigation system or another vehicle-mounted information system.

Furthermore, although in Embodiment 1 audio data recorded in the CD 5 is recorded in the data recording device 3, the recording medium in which audio data is recorded is not limited to the CD 5, and a recording medium, such as an MD (Mini Disc), a DVD (Digital Versatile Disk), a BD, a flash memory, or an HDD, can be alternatively used. In the case in which a recording medium other than the CD 5 is used, a reader ready for the recording medium which is used is disposed instead of the CD drive 2 so that any of those recording media can be used.

Furthermore, although in Embodiment 1 audio data is recorded in the CD 5, the information recorded in the CD is not limited to audio data and can be video information. As a recording medium in which video information is recorded, another recording medium as mentioned above other than the CD 5 can be used. In this case, what is necessary is just to connect a display instead of the speaker 4.

Furthermore, although in Embodiment 1 the FAT file system 105 is used in the control unit 11, another file system can be alternatively used.

Furthermore, although in Embodiment 1 the FAT file system 105 divides the first write request received from the application 103 into the four third write requests, the number of divided requests is not limited to four.

Although in Embodiment 1 the journaling driver 106 writes metadata into the file system region in response to a commit request from the application 103, the journaling driver can alternatively write metadata into the file system region when the data written into the journal log region has a data volume equal to or larger than a predetermined amount or when a certain time has elapsed after data has been finally written.

### Embodiment 2

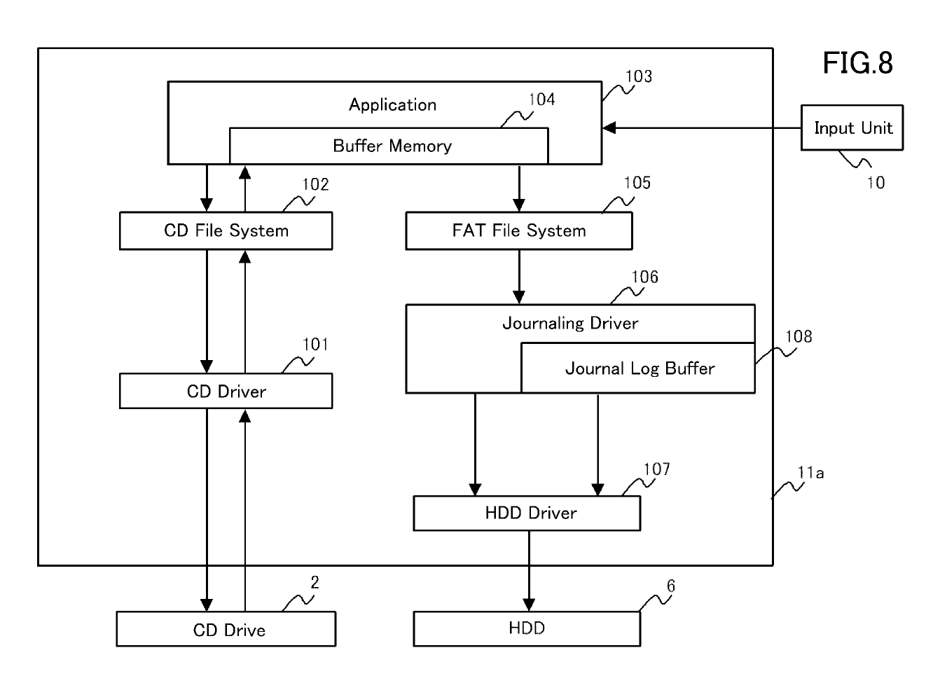

Although in Embodiment 1 a journal log is recorded in the HDD 6 directly from the buffer memory 104, a journal log can be written into the HDD 6 after recorded in the DRAM 7. FIG. 8 is a functional block diagram showing a CD drive 2 and a data recording device 3 in accordance with Embodiment 2. In the figure, the same components as those shown in FIG. 2 or like components are designated by the same reference numerals, and the explanation of the components will be omitted hereafter.

In FIG. 8, when a requested write amount indicated by a second or third write request is smaller than 64 KB, a journaling driver 106a outputs the data which the journaling driver is requested to write into an HDD 6, information about a write start sector, and information about the number of write sectors included in the second or third write request to a journal log buffer 108 (temporary recording unit). An operation of the journaling driver when the requested write amount is equal to or larger than 64 KB is the same as that of the journaling driver 106 in accordance with Embodiment 1.

Furthermore, when receiving a commit request outputted from an application 103, the journaling driver 106a creates a journal log from the data recorded in the journal log buffer 108. The journaling driver then makes a request of an HDD driver 7 to write the journal log created thereby in a journal log region of the HDD 6.

A restoring method which the data recording device in accordance with Embodiment 2 uses when inconsistency occurs in data recorded in a recording region on the HDD 6 is executed according to a procedure which is the same as that shown in the flow chart of FIG. 7. No problem arises when a fault occurs while the HDD driver 7 writes a journal log into the HDD 6 because a file system region of the HDD 6 is not changed at all. In this case, because the writing of the journal log is not completed, the data recording device determines that there is no data to be restored and ends the processing.

Even if a fault occurs, a general journaling file system can restore the HDD 6 to its original state immediately before the occurrence of the fault by recording a journal log in the HDD 6 for every transaction. In contrast, the data recording device 3 in accordance with Embodiment 2 does not record a journal log for every transaction. Instead, after the completion of a plurality of transactions, the data recording device 3 records a journal log when the journal log buffer 108 is full or when a certain time has elapsed after data has been finally written into the journal log buffer 108. As a result, the data recording device can reduce the number of times that the data recording device writes data into the HDD 6, and hence can increase the longevity of the HDD. Furthermore, because the reduction in the number of times that the data recording device writes data into the HDD results in reduction in the risk of occurrence of a system breakdown in writing data into the HDD, the fault tolerance can be improved. In addition, the recording of data can be speeded up by writing journal logs collectively.

Although the data recording device in accordance with Embodiment 2 temporarily records a journal log in the DRAM 7, the data recording device can alternatively record a journal log in a memory disposed separately from the DRAM 7.

Although the journaling driver 106a in accordance with Embodiment 2 makes a request of the HDD driver 7 to write a journal log into the journal log region of the HDD 6 when receiving a commit request outputted from the application 103, the journaling driver can alternatively check the volume of the data written into the journal log buffer 108 or the time which has elapsed after data was finally written into the journal log buffer at the time of receiving a commit request, and, when the data written into the journal log buffer 108 has an amount equal to or larger than a predetermined amount, such as when the remaining recordable capacity of the journal log buffer 108 is small (the remaining storage capacity is twenty percent), or when a predetermined time (e.g., 60 seconds) has elapsed after data has been finally written into the journal log buffer, the journaling driver can make a request of the HDD driver 7 to write a journal log into the journal log region of the HDD 6.

### EXPLANATIONS OF REFERENCE CHARACTERS

1 Audio system, 2 CD drive, 3 Data recording device, 4 Speaker, 5 CD, 6 HDD, 7 DRAM, 8 ROM, 9 CPU, 10 Input unit, 11 Control unit, 105 FAT file system, 106 and 106a Journaling driver, 108 Journal log buffer

1. A data recording device comprising:
a recording unit for recording a data file therein;
an FAT file system without a fault restoration function, for managing said data file recorded in said recording unit; and
a writing control unit for writing said data file and management data about said data file in said recording unit in response to a request from said FAT file system, wherein
said writing control unit writes said write data at a position where said writing control unit is requested to write said write data by said FAT file system when said write data which said writing control unit is requested to write by said FAT file system has a data volume equal to or larger than a predetermined value while writing said write data in a region in said recording unit different from that managed by said FAT file system and then writes said write data written in said different region at the position where said writing control unit is requested to write said write data by said FAT file system when said write data has a data volume smaller than said predetermined value.

2. The data recording device according to claim 1, wherein said data recording device includes a temporary recording unit for temporarily recording said write data, and said writing control unit temporarily records said write data in said temporary recording unit when said write data has a data volume smaller than the predetermined value, and writes said write data recorded in said primary recording unit in said different region when the data volume of said write data recorded in said temporary recording unit becomes equal to or larger than the predetermined amount or when a predetermined time has elapsed after said write data has been finally written.

3. An audio system comprising:
a reading device for reading audio data from a recording medium in which said audio data are recorded;
a data recording device according to claim 1 for recording said audio data outputted from said reading device therein; and
an audio output device for outputting a sound according to the audio data outputted from said reading device or said data recording device.

4. An audio system coin
a reading device for reading audio data from a recording medium in which said audio data are recorded;
a data recording device according to claim 2 for recording said audio data outputted from said reading device therein; and
an audio output device for outputting a sound according to the audio data outputted from said reading device or said data recording device.
